(19) United States
(12) Patent Application Publication
(10) Pub. No.: US 2026/0236856 A1
(43) Pub. Date: Aug. 13, 2026

(54) SYSTEM, METHOD, AND COMPUTER PROGRAM PRODUCT FOR PROVIDING SUPPORT TO A USER WANTING TO GO FISHING

(71) Applicant: VOLVO PENTA CORPORATION, Göteborg (SE)

(72) Inventor: Joakim SÄLLBERG, Göteborg (SE)

(73) Assignee: VOLVO PENTA CORPORATION, Göteborg (SE)

(21) Appl. No.: 19/150,804

(22) PCT Filed: Jan. 27, 2023
(86) PCT No.: PCT/EP2023/052055

§ 371 Date: Jul. 24, 2025

(51) Int. Cl. G06Q 10/02; G01W 1/10; G06Q 30/0251; G06Q 30/0645

(52) U.S. Cl. CPC G06Q 10/026; G01W 1/10; G06Q 30/0261; G06Q 30/0645

(57) ABSTRACT

A system supporting to a user wanting to go fishing. The system has a processor-based device; a first system configured to provide weather forecast data; a second system configured to store predefined fishing locations, wherein each predefined location is associated with at least calendar time data and corresponding weather conditions. The processor-based device is configured to contact the first system to obtain weather data for a fishing time desired by the user; and to access the second system to retrieve, based on the weather data obtained and the desired fishing time, one or more selectable fishing locations for the user.

### TECHNICAL FIELD

The disclosure relates generally to the field of fishing. In particular aspects, the disclosure relates to a system, a method, and a computer program product for providing support to a user wanting to go fishing.

The present disclosure will be described by making particular reference, as a possible example, to users using boats for fishing, without intending in any way to limit its possible applications.

Indeed, as it will result clearly from the following description, the present disclosure can be applied in principle to any type of fishing activities, be them for leisure, sport or business fishing sessions, and also when going fishing with or without any boat, e.g. fishing from land, like from beaches, rocks, rivers, et cetera.

### BACKGROUND

As known, fishing is a widespread activity, not only for business reasons, but it is also a very popular recreational or sport activity, for example among leisure craft users.

Unfortunately, fishing sessions can be impacted by several factors, such as the weather conditions, the period where a user desires to go fishing, and also the fishing location chosen which may not the best choice for the fishing period selected by users.

As a consequence, one or more of these factors may render a fishing session not satisfactory as desired by a user.

Hence, the present invention is aimed at facing and at least mitigating such issues, and in particular at realizing a solution capable of providing supporting information to a user wanting to go fishing to render fishing sessions as satisfactory as possible.

### SUMMARY

According to a first aspect of the disclosure, there is provided a system for providing support to a user wanting to go fishing, the system comprising at least:
a processor-based device;
a first system configured to provide weather forecast data;
a second system configured to store predefined fishing locations, wherein each predefined location is associated with at least calendar time data and corresponding weather conditions; wherein the processor-based device is configured:
to contact the first system to obtain weather data for a fishing time desired by the user; and
to access the second system to retrieve, based on the weather data obtained and the desired fishing time, one or more selectable fishing locations for the user.

This first aspect of the disclosure may seek to provide supporting information helping users, who want to go fishing, to select in advance a suitable fishing location, possibly minimizing the potential negative impact of one or more factors, such as weather conditions, the specific period where a user desires to go fishing, and also the fishing location chosen. In this way, users may experience more satisfying fishing sessions.

In some examples, the system comprises a display for displaying to the user the one or more selectable fishing locations retrieved. In this way, user may see directly the proposed selectable fishing locations, and may quickly evaluate at a glance the one(s) more convenient to be reached.

In some examples, the second system is further configured to provide for the user at least one list of suitable fishing equipment associated to one or more of the selectable fishing locations retrieved by the user.

In one example, the second system is configured to automatically provide for the user at least one list of suitable fishing equipment associated to one or more of the selectable fishing locations retrieved by the user.

In another example, the processor-based device is further configured to contact the second system to thereby obtain for the user at least one list of suitable fishing equipment associated to one or more of the selectable fishing locations retrieved by the user.

According to the above examples, users may be supported also to know in advance the fishing equipment needed, in particular relative to the fishing location(s) selectable.

In some possible examples, the processor-based device is further configured to contact one or more on-line equipment vendors to thereby obtain proposed fishing equipment lists.

In one possible example, the system is configured to provide for the user at least a list of fishing equipment available for purchase or rent.

According to these examples, users may be supported also in getting (buying or renting) any fishing equipment needed.

In some possible examples, at least one of the second system and the processor-based device is further configured to provide for the user at least one list of suggested supplies based on at least one of: the desired fishing time; the weather data retrieved; the one or more fishing locations retrieved. In this way, users may be supported also to know in advance the fishing some suggested supplies needed, such as food and beverage or any other type of supply, in particular relative to the fishing location(s) selectable, the desired fishing time, the relevant weather data.

In some possible examples, the system comprises at least one booking system for the user to book one or more of a food serving facility and/or a lodging facility at at least one selected fishing location of the one or more selectable fishing locations. Accordingly, users can get support and book in advance whatever facility may be needed at the fishing location(s) selected or to be selected.

According to a second aspect of the disclosure, there is provided also a method for providing support to a user wanting to go fishing, the method (200) comprising:
(a): contacting, via a processor-based device, a first system configured to provide weather forecast data, thereby obtaining weather data related to a fishing time desired by the user;
(b): accessing a second system configured to store predefined fishing locations, wherein each predefined location is associated with at least calendar time data and associated weather conditions, thereby retrieving, based on the weather data obtained and the desired fishing time, one or more selectable fishing locations for the user.

In some possible examples, the method comprising displaying to the user the one or more selectable fishing locations retrieved.

In some possible examples, the method comprises providing for the user, via the second system, at least one list of suitable fishing equipment associated to one or more of the selectable fishing locations retrieved by the user.

In particular, in one possible example of the method, the second system automatically provides for the user the at least one list of suitable fishing equipment associated to one or more of the selectable fishing locations retrieved by the user.

In another possible example of the method, the processor-based device is further configured to contact the second system to thereby obtain for the user the at least one list of suitable fishing equipment associated to one or more of the selectable fishing locations retrieved by the user.

In some possible examples, the method further comprises contacting, via the processor-based device, one or more on-line equipment vendors to thereby obtain for the user proposed fishing equipment lists.

In some possible examples, the method comprises providing for the user, via a third system, at least a list of fishing equipment available for purchase or rent.

In yet some other examples, the method comprises providing for the user, via at least one of the second system and the processor-based device, at least one list of suggested supplies based on at least one of: the desired fishing time; the weather data retrieved; the one or more fishing locations retrieved.

In some possible examples, the method comprises booking, via a booking system one or more of a food serving facility and/or a lodging facility at at least one selected fishing location of the one or more selectable fishing locations.

Thanks to the method according to the present disclosure, the same/similar technical benefits and advantages described in connection with the above system may be achieved.

According to a further aspect of the disclosure, there is provided a computer program product comprising program code for performing, when executed by a processor device, the method as above indicated. In this way, the various functionalities/steps above described may be implemented easily via any desired and suitable processor device.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 is an exemplary block diagram showing a system for providing support to a user wishing to go fishing, according to one example.

FIG. 2 is a flow chart of an exemplary method for providing support to a user wishing to go fishing, according to one example.

### DETAILED DESCRIPTION

Aspects set forth below represent the necessary information to enable those skilled in the art to practice the disclosure.

As previously mentioned, when a user desires to go fishing, the fishing session may be influenced by several factors, e.g. the relevant calendar period intended for fishing, the fishing location selected, the specific weather conditions. Indeed, for example the same fishing location may turn to be very enjoyable or unsatisfactory depending on the period selected, and current weather conditions may in any case heavily influence the fishing experience at a selected location and at a certain time.

The present disclosure provides a solution capable of timely providing users with support enabling them to select an appropriate fishing location where to go fishing, in particular taking into account in advance the weather conditions and the calendar period selected for fishing.

As it will be described in more details hereinafter, the solution according present disclosure can be implemented for example as a system, a method, and a computer product program for providing support to a user wanting to go fishing.

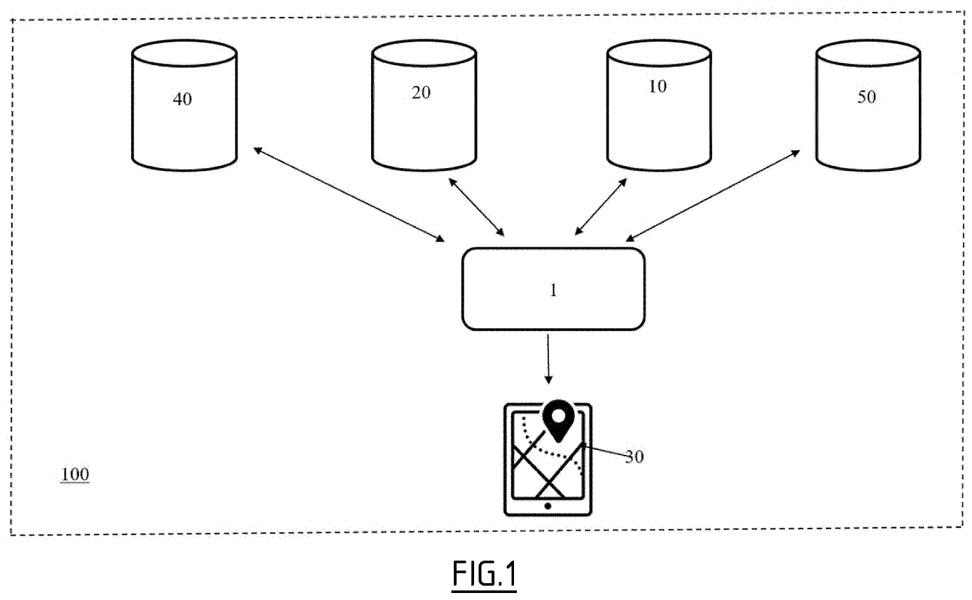

In particular, FIG. 1 schematically illustrates an example of a system for providing support to a user wanting to go fishing, indicated by the overall reference number 100.

In one possible example, the illustrated system 100 comprises at least:
a processor-based device 1;
a first system 10 configured to provide weather forecast data;
a second system 20 configured to store predefined fishing locations, wherein each predefined location is associated with at least calendar time data and corresponding weather conditions.

In particular, the processor-based device 1 is configured, based on input from a user, at least:
to contact the first system 10 to obtain weather data for a fishing time desired by the user; and
to access the second system 20 to retrieve, based on the weather data obtained and the desired fishing time, one or more selectable fishing locations for the user.

The fishing time desired can be any time input by a user, for example, part of a day, an entire day, more than one day.

The first and second systems 10 and 20 can comprise or be constituted by respective servers, e.g. cloud based servers and/or servers installed physically in positions even remote to each other.

For instance the first system 10 may be constituted by or comprise any provider system or server suitable to provide meteorological forecasts,

The second system 20 may be constituted by or comprise any system or server suitable to provide information about fishing locations, such as the one available from the Swedish organisation Sportfiskarna.

The processor-based device 1 can be any suitable processor-based device, such as a fixed or portable computer, a notebook, a smartphone, etc., capable of including circuitry, firmware, hardware, and/or executing software instructions to implement the functionalities/steps described herein. For example, a number of modules can be implemented as software and/or hard-coded in circuitry to implement the functionalities/steps described herein in whole or in part. The modules may be stored in a storage device or memory of the device 1.

In particular, depending on the applications, the processor-based device 1 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor-based device 1 may further include computer executable code that controls operation of the device 1 itself.

In one possible example, the system 100 further comprises a display, indicated in FIG. 1 by the reference number 30 for displaying to the user the one or more selectable fishing locations retrieved.

For example, the one or more fishing locations retrieved can be evidenced on a digital map, shown on the display 30, where the user can also see distances and judge at a glance if any of the fishing locations retrieved may be truly interesting for being selected and going there for fishing.

The display 30 can be a display external and operatively associated to the processor-based device 1 or part thereof, as it can be the case for instance if the device 1 is a smartphone, a portable computer or a notebook.

For instance, any location selected can be shown on a display of a boat that the user uses for going fishing, and the route from the starting point to the selected fishing location a may be calculated by or input into the onboard navigation system of the used boat.

In one possible example, the second system 20 is further configured to provide for the user at least one list of suitable fishing equipment associated to one or more of the selectable fishing locations.

In one possible example, the system 20 can automatically provide the list of suitable fishing equipment associated to one or more, preferably all, the selectable fishing locations, and in particular associated to those retrieved by the user.

In another possible example, the processor-based device 1 is further configured to contact the system 20 to thereby obtain for the user at least one list of suitable fishing equipment for one or more of the selectable fishing locations retrieved.

In addition and/or in alternative, the processor-based device 1 is further configured to contact one or more on-line equipment vendors or the like, from which a user can receive proposed fishing equipment lists, and perhaps also order missing fishing equipment, for example based on a fishing location selected or likely to be selected, and/or the desired time for going fishing, and/or the corresponding weather conditions.

In one possible example, the system 100 further comprises a third system 40 configured to provide for the user at least a list of fishing equipment available for purchase or rent.

In particular, in one possible example the processor-based device 1 is further configured to interface with the third system 40 to obtain at least a list of fishing equipment available for purchase or rent.

For instance, the third system 40 may be constituted by or comprise any on-line store, vendor, marketplace, or server or the like, selling and/or renting suitable fishing equipment.

In one possible example, at least one of the second system 20 and the processor-based device 1 is further configured to provide for the user at least one list of suggested supplies based on at least one of: the desired fishing time; the weather data retrieved; the one or more fishing locations retrieved.

For instance, once a user has selected a desired fishing location among the one or more retrieved, the processor-based device 1 or the second system 20 is programmed to propose a list of supplies, such as food and beverage, suitable for a selected location.

Then, the use can order directly on line what desired, and the ordered supplies, such as any fishing equipment purchased or rent, can be delivered at the starting point or even at the fishing location selected.

In one possible example, the system 100 further comprises a fourth system 50 for the user to book one or more of a food serving facility, e.g. restaurants, and/or a lodging facility, e.g. any hotel, at at least one selectable fishing location of the one or more selectable fishing locations.

In particular, a user, for instance via the processor based-device 1, can contact directly online the system 50 in order to retrieve information and in case directly book any food serving facility and/or lodging facility, for any selected fishing location among the one or more selectable fishing locations retrieved.

For instance, the fourth system 50 may be constituted by or comprise any on-line booking system, server, or the like, suitable for booking food serving and lodging facilities.

The various systems 10, 20, 40, 50 and the processor-based device 1 may communicate with each other in any suitable way, thus exploiting any suitable telecommunications systems.

Further, one or more of such systems may comprise or be constituted by any system, server, store or the like, available and accessible freely on line, or some of them or all can be organized to form a fully proprietary system/subsystem which can be used and accessed based on a to-be-authorized right, e.g. via payment of a subscription and/or membership.

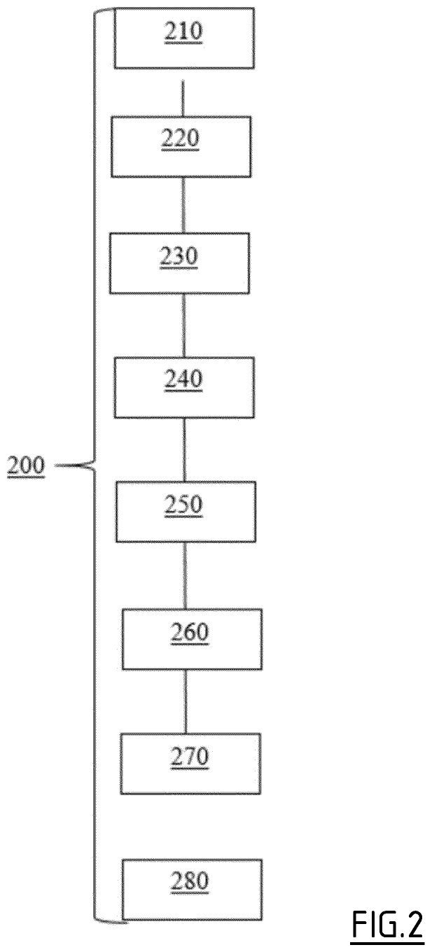

FIG. 2 illustrates an example of a method 200 for providing support to a user wanting to go fishing, comprising:
210: contacting, via a processor-based device 1, a first system 10 configured to provide weather forecast data, thereby obtaining weather data related to a fishing time desired by the user;
220: accessing a second system 20 configured to store predefined fishing locations, wherein each predefined location is associated with at least calendar time data and associated weather conditions, thereby retrieving, based on the weather data obtained and the desired fishing time, one or more selectable fishing locations for the user.

In one example, the method 200 further comprises (at step 230) displaying to the user, for example on a display 30, the one or more selectable fishing locations retrieved.

In another possible example, the method 200 further comprising providing (at step 240) for the user, via the second system 20, at least one list of suitable fishing equipment associated to one or more of the selectable fishing locations retrieved by the user.

In particular, in a possible example the second system 20 automatically provides for the user the at least one list of suitable fishing equipment associated to one or more of the selectable fishing locations retrieved by the user.

In yet another example, the processor-based device 1 is further configured to contact the second system 20 to thereby obtain for the user the at least one list of suitable fishing equipment associated to one or more of the selectable fishing locations retrieved by the user.

In one example, the method 200 further comprises contacting (at step 250), via the processor-based device 1, one or more on-line equipment vendors to thereby obtain for the user proposed fishing equipment lists.

In another possible example, the method 200 further comprises providing (at step 260) for the user, via a third system 40, at least a list of fishing equipment available for purchase or rent.

In yet a further example, the method 200 further comprises providing (at step 270) for the user, via at least one of the second system 10 and the processor-based device 1, at least one list of suggested supplies based on at least one of: the desired fishing time; the weather data retrieved; the one or more fishing locations retrieved.

In a further example, the method 200 further comprises booking (at step 280), via a booking system 50, one or more of a food serving facility and/or a lodging facility at at least one selected fishing location of the one or more selectable fishing locations.

As those skilled in the art may readily appreciate, the operational functionalities/steps described in any of the exemplary aspects herein are described to provide examples and discussion. Although a specific order of method steps has been shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms.

These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

For instance, when the term “adapted” or “arranged” or “configured” or “shaped”, have been used herein while referring to any component as a whole, or to any part of a component, or to a combination of components, it has to be understood that it means and encompasses correspondingly either the structure, and/or configuration and/or form and/or positioning of the related component or part thereof, or combinations, such term refers to.

In particular, for electronic and/or software means, each of the above listed terms means and encompasses electronic circuits or parts thereof, as well as stored, embedded or running software codes and/or routines, algorithms, or complete programs, suitably designed for achieving the technical result and/or the functional performances for which such means are devised.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A system for providing support to a user wanting to go fishing, the system comprising at least:
a processor-based device;
a first system configured to provide weather forecast data;
a second system configured to store predefined fishing locations, wherein each predefined location is associated with at least calendar time data and corresponding weather conditions; wherein,
the processor-based device is configured:
to contact the first system to obtain weather data for a fishing time desired by the user; and
to access the second system to retrieve, based on the weather data obtained and the desired fishing time, one or more selectable fishing locations for the user.

2. The system of claim 1, further comprising a display for displaying to the user the one or more selectable fishing locations retrieved.

3. The system of claim 1, wherein the second system is further configured to provide for the user at least one list of suitable fishing equipment associated to one or more of the selectable fishing locations retrieved by the user.

4. The system of claim 3, wherein the second system is configured to automatically provide for the user at least one list of suitable fishing equipment associated to one or more of the selectable fishing locations retrieved by the user.

5. The system of in claim 3, wherein the processor-based device is further configured to contact the second system to thereby obtain for the user at least one list of suitable fishing equipment associated to one or more of the selectable fishing locations retrieved by the user.

6. The system of claim 1, wherein the processor-based device is further configured to contact one or more on-line equipment vendors to thereby obtain proposed fishing equipment lists.

7. The system of claim 1, further comprising a third system configured to provide for the user at least a list of fishing equipment available for purchase or rent.

8. The system of claim 1, wherein at least one of the second system and the processor-based device is further configured to provide for the user at least one list of suggested supplies based on at least one of: the desired fishing time; the weather data retrieved; the one or more fishing locations retrieved.

9. The system of claim 1, further comprising at least one booking system for the user to book one or more of a food serving facility and/or a lodging facility at at least one selected fishing location of the one or more selectable fishing locations.

10. A method for providing support to a user wanting to go fishing, the method comprising:
contacting, via a processor-based device a first system configured to provide weather forecast data, thereby obtaining weather data related to a fishing time desired by the user;
accessing a second system configured to store predefined fishing locations, wherein each predefined location is associated with at least calendar time data and associated weather conditions, thereby retrieving, based on the weather data obtained and the desired fishing time, one or more selectable fishing locations for the user.

11. The method of claim 10, further comprising displaying to the user the one or more selectable fishing locations retrieved.

12. The method as in claim 10, further comprising providing for the user, via the second system, at least one list of suitable fishing equipment associated to one or more of the selectable fishing locations retrieved by the user.

13. The method of claim 12, wherein the second system automatically provides for the user the at least one list of suitable fishing equipment associated to one or more of the selectable fishing locations retrieved by the user.

14. The method of claim 12, wherein the processor-based device (1) is further configured to contact the second system to thereby obtain for the user the at least one list of suitable fishing equipment associated to one or more of the selectable fishing locations retrieved by the user.

15. The method of claim 10, further comprising contacting, via the processor-based device one or more on-line equipment vendors to thereby obtain for the user proposed fishing equipment lists.

16. The method of claim 10, further comprising providing for the user, via a third system, at least a list of fishing equipment available for purchase or rent.

17. The method of claim 10, further comprising providing for the user, via at least one of the second system and the processor-based device, at least one list of suggested supplies based on at least one of: the desired fishing time; the weather data retrieved; the one or more fishing locations retrieved.

18. The method of claim 10, further comprising booking, via a booking system one or more of a food serving facility and/or a lodging facility at at least one selected fishing location of the one or more selectable fishing locations.

19. A non-transitory computer program product comprising program code for performing, when executed by a processor device, the method of claim 10.
